(19) United States
(12) Patent Application Publication
(10) Pub. No.: US 2004/0226905 A1
(43) Pub. Date: Nov. 18, 2004

(54) Disposable snack or medicine dose for infants

(76) Inventor: Philip M. Diniaco, Canonsburg, PA (US)

Correspondence Address: William L. Krayer, 1771 Helen Drive, Pittsburgh, PA, 15216, US

(21) Appl. No.: 10/842,990

(22) Filed: May 11, 2004

Related U.S. Application Data
(60) Provisional application No. 60/471,280, filed on May 16, 2003.

(51) Int. Cl. A61J 9/04

(52) U.S. Cl. 215/11.1; 606/236

(57) ABSTRACT

A disposable liquid container and dispensing device suitable as a snack for an infant comprising a nipple member and a collapsible reservoir. The collapsible reservoir contains a small portion of liquid such as baby formula or juice and is preferably constructed of material flexible enough so that it may collapse into the interior of the nipple when substantially empty. Several such containers is arranged in a convenience pack for traveling or other use.

### RELATED APPLICATION

This application claims the full benefit of my Provisional Application Serial No. 60/471,280 filed May 16, 2003, having the same title.

### BACKGROUND OF THE INVENTION

There is a need for a convenient method of providing infants with small amounts of liquid. The liquid may be a small amount of milk or liquid formula, or a dosage of medicine. Desirably, the container would be prepackaged, including a nipple and a small amount of formula, juice, or other liquid, requiring essentially no preparation and being disposable. Such a device would be particularly useful and beneficial during travel or in circumstances where it is difficult to prepare a full bottle or inconvenient to nurse the infant. Nursing requires that motorists pull off the road in order to move the infant from the infant car seat.

### SUMMARY OF THE INVENTION

I have invented a disposable infant snack or medicine dispenser which requires no preparation by the user.

In the preferred form of my invention, there are four components—a nipple, a mouthguard, a collapsible reservoir, and a liquid substantially filling the collapsible reservoir. The liquid will substantially fill the nipple as well as the reservoir, although this is not essential to my invention. The contents of the reservoir/nipple may be milk, juice, infant formula, a solution of electrolyte, vitamins, or medication. The reservoir may be constructed in such a way as to eliminate the need for a separate mouthguard.

### BRIEF DESCRIPTION OF THE DRAWINGS

FIG. 1 is a perspective view of a preferred version of the assembled liquid dispensing device of my invention.

FIG. 2 is a side sectional view of a preferred construction of the invention.

In FIG. 3, a perspective view of an alternative preferred construction is presented.

FIGS. 4a and 4b show a preferred mouthguard construction and a connection between the reservoir and the nipple in the assembled device of FIG. 3.

FIG. 5 shows the device of FIGS. 3 and 4 after use, with the reservoir collapsed into the nipple.

In FIG. 6, a vacuum formed 6-pack of my invention is shown ready for retailing.

### DETAILED DESCRIPTION OF THE INVENTION

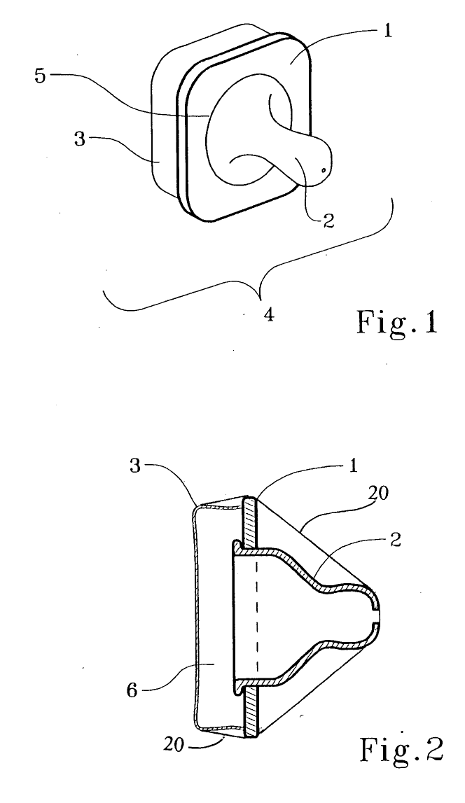

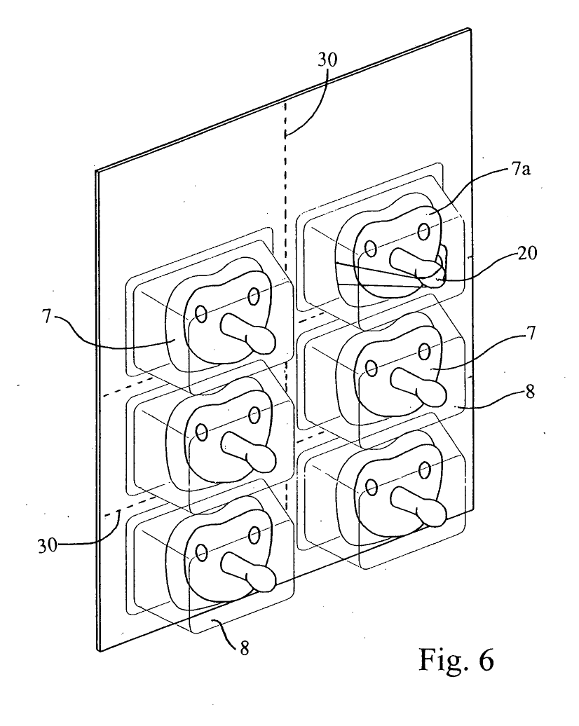

In FIG. 1, mouthguard 1 is fixed in sealed relation to nipple 2, and reservoir 3 is fixed in sealed relation to mouthguard 1. Together, the mouthguard 1 and nipple 2 form a mouthpiece 4. Nipple 2 is made of any conventional rubbery substance normally used for infant nipples, and mouthguard 1 is preferably made of a more rigid material, such as a synthetic plastic. While the nipple 2 may be compression fit or inserted in a form-fitting manner through a hole 5 in mouthguard 1 without chemical sealing, it is preferred that the nipple 2 is heat-sealed, chemically sealed, or otherwise fixed in leak-free relation to the mouthguard 1. Compression fitting is preferred to minimize the chemical content of the device. The nipple and mouthguard may be molded as a single unitary device. Reservoir 3 is chemically sealed or heat sealed or compression fit around the periphery of mouthguard 1, and is filled with a liquid not shown. Reservoir 3 is made of a highly flexible film so that it will collapse completely on being emptied and is capable of collapsing completely onto the rear surface of the mouthguard 3 and form-fitting the inside of the nipple 2, as will be seen in FIG. 5.

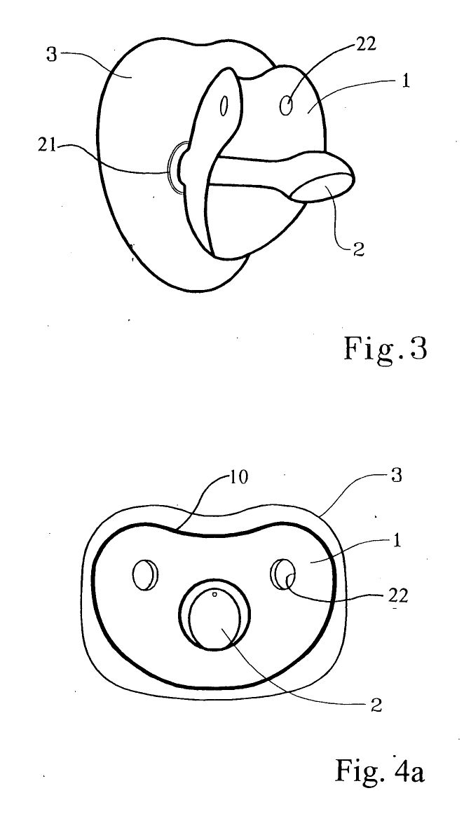

In FIG. 2, a simplified section of a preferred construction shows the nipple 2, mouthguard 1, reservoir 3, and liquid 6. Liquid 6 may be a nutrient such as milk, a milk substitute formula, juice, or water, or a liquid vitamin solution or liquid medicine. There is no valve or other obstruction between the nipple 2 and the reservoir 3. Reservoir 3, together with the volume within nipple 2, holds several ounces, for example up to three ounces or more of liquid in this preferred configuration. Preferably there is no air in either the reservoir or the nipple—that is, the liquid substantially fills the total volume of the reservoir and nipple. A preferred amount of liquid will be from one-fourth ounce to 2.5 ounces, more preferably from one-half ounce to two ounces, and most preferably from three-quarters ounce to 1.5 ounces. A band 20 covering at least a portion of the device is intended to block or seal off the open end of the nipple 2 so that liquid will not escape in the package or prematurely when the user is ready to dispense. It may completely encircle or completely enclose the device. The user simply removes the band 20 or other cover and the device is ready for the infant to use. Preferably the band 20 has no adhesive in contact with the nipple 2; any cover effective to prevent leakage through the front end of the nipple 2 is contemplated within the scope of my invention. Preferably it may be a clinging type of film. Reservoir 3 and mouthguard 1 may be a unitary element. That is, the reservoir 3 may incorporate mouthguard 1 as a part of it, forming a continuous flexible sheet fitting around the base of nipple 2. Preferably the portion shown as mouthguard 1 will nevertheless be somewhat stiff and larger in diameter than the base of nipple 2.

The FIG. 3 configuration shows a construction wherein the reservoir 3 is sealably fixed directly at 21 to the nipple 2 rather than to mouthguard 1. In the manufacturing process, the mouthguard may be added to the nipple/reservoir before or after filling the reservoir/nipple with liquid. This variation also illustrates optional vent holes 22.

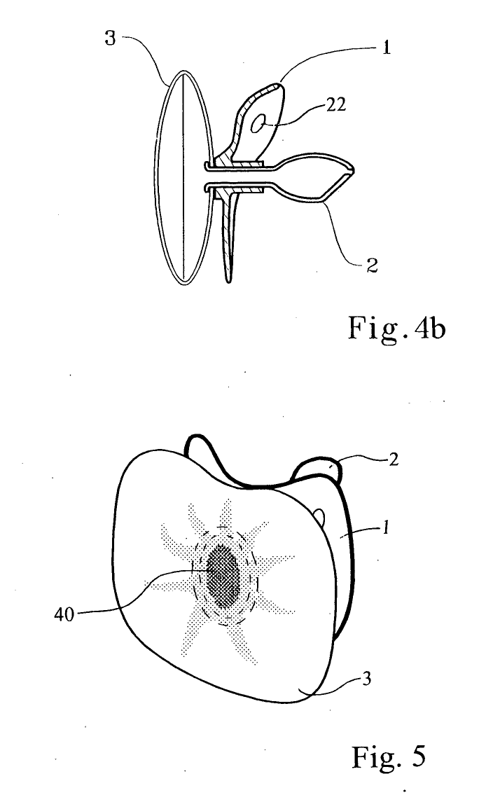

In FIGS. 4a and 4b, a variation of the FIG. 3 configuration is shown. In particular, the mouthpiece has a concave curve 10 in order to avoid discomfort by contact with the infant's nose.

The perspective of FIG. 5 is offered to show the device after use. It will be seen that the reservoir 3 has collapsed, not only to near the level of the mouthguard 1, but into the base opening 40 of nipple 2. Preferably the shape, design and volume of the reservoir 3 will be selected to assure that, when the reservoir 3 collapses into nipple 2, it will have emptied completely and will also empty liquid from the interior of nipple 2. Although the infant will have consumed the contents of the reservoir, he or she could, of course, continue to use the device, preferably temporarily, as a pacifier. Otherwise, it may be discarded.

FIG. 6 is a perspective view of a package suitable for retail, in which six of my devices are displayed, ready for use. The devices 7 are substantially sterilized both as to the contents of the reservoir to provide an appropriate shelf life but also on the nipple surface in particular. The “six-snack” package shows each device in an individual airtight container 8. In this illustration, perforations 30 enable the purchaser to separate one snack device at a time in order to preserve the sterility of the others, leaving them in the package. Also in this example, one device 7a is shown with a protective or sealing band 20. The band 20 or other separate closure for the front end of the nipple may not be necessary if the container 8 is designed to perform its function. Any convenient number of snack devices can be placed in such a container. The devices may also be packed back-to-back or stacked, but in any case it is preferred that each device have its own separate sterile container.

1. A liquid dispensing device for an infant comprising (a) a mouthpiece comprising a flexible nipple and a mouthguard affixed to said nipple, (b) a collapsible reservoir affixed in sealed relation to said mouthpiece to permit the passage of liquid from said reservoir into said nipple, and (c) a liquid substantially filling said reservoir.

2. Liquid dispensing device of claim 1 which is substantially sterilized and packaged in a container having a substantially sterile interior.

3. Liquid dispensing device wherein said liquid also substantially fills said nipple.

4. Liquid dispensing device of claim 1 wherein said liquid comprises a milk substitute formula.

5. Liquid dispensing device of claim 1 wherein said liquid comprises juice.

6. Liquid dispensing device of claim 1 wherein said liquid comprises vitamins.

7. Liquid dispensing device of claim 1 wherein said liquid comprises medicine.

8. Liquid dispensing device of claim 1 wherein said collapsible reservoir has a volume at least equal to the volume of the interior of said nipple.

9. Liquid dispensing device of claim 1 wherein said collapsible reservoir is fixed in sealed relation to said mouthguard.

10. Liquid dispensing device of claim 1 including a readily removable cover for the end of said flexible nipple.

11. Liquid dispensing device of claim 10 wherein said readily removable cover is a band encircling said device.

12. Liquid dispensing device of claim 1 wherein said collapsible reservoir is fixed in sealed relation to said nipple.

13. A package comprising a plurality of substantially sterile liquid dispensing devices of claim 1 in a substantially sterile container.

14. Package of claim 13 wherein each of said devices of claim 1 is in a separate substantially separate compartment in said package.

15. An infant liquid snack comprising a collapsible container, liquid nutrient in said container, and a nipple attached in leakfree relation to said container.

16. An infant liquid snack of claim 15 wherein said liquid nutrient fills substantially the entire volume of said collapsible container and said nipple.

17. An infant liquid snack of claim 15 including a mouthguard thereon.

18. An infant liquid snack of claim 15 wherein said collapsible container, when emptied, is capable of collapsing into said nipple.

19. A packet comprising a plurality of infant snacks of claim 15 in a substantially sterile container.

20. A disposable liquid container and dispensing device for an infant comprising a nipple member and a collapsible reservoir member, said collapsible reservoir member being constructed of material flexible enough so that it may collapse into the interior of said nipple member when substantially empty.
